(19) United States
(12) Patent Application Publication
(10) Pub. No.: US 2011/0241981 A1
(43) Pub. Date: Oct. 6, 2011

(54) Input Routing for Simultaneous USB Connections of Similar Device Types

(76) Inventor: Lena Sojian, Fountain Valley, CA (US)

(21) Appl. No.: 12/750,584

(22) Filed: Mar. 30, 2010

(51) Int. Cl. G09G 5/00; G06F 13/38

(52) U.S. Cl. 345/156; 710/63

(57) ABSTRACT

Methods and devices for accommodating a plurality of interface devices via a Universal Serial Bus (USB) that include: (a) receiving a set of settings for an interface device; (b) generating an input/output (I/O) device handle associated with the interface device; (c) comparing the received interface device settings set with one or more entries of a device-matching criteria database; and (d) if the received set of interface device settings matches an entry of the device matching criteria database, then: (i) generating a device manager handle associated with the interface device; and (ii) spawning a device manager thread based on the generated I/O device handle.

### TECHNICAL FIELD

Embodiments pertain to routing input data from multiple input devices to multiple applications for processing where the applications selectively register to receive data.

### BACKGROUND

A computing device may support a keyboard device. The keyboard device may be the primary mechanism by which a user interacts with the computing device and an application program running within the computing device. A keyboard device of a computing device is generally closely coupled with the user interface. For example, an application program that handles the user interface will register to obtain all keystroke data typed on a keyboard device. That is, a user may type on the keyboard, i.e., keystrokes that depress or designate keys, and these keystrokes are interpreted and displayed via the user interface display. Typically, when a Universal Serial Bus (USB) Human Interface Device (HID) device is initially plugged into a computer, the USB drivers on the computer enumerate the device to extract information such as Vendor Identification (ID), Product ID, and one or more Device Descriptors. These fields are defined in the USB Specification. Generally, a USB interface is a standard interface between PCs and peripherals, and has become a de facto commercial interface for keyboard devices, i.e., for USB keyboards that may plug directly into a USB port on a computing device, such as a multifunction peripheral (MFP) device.

Presently, if more than one USB keyboard device is attached to the computing device, the input by way of each of the two or more keyboard devices attached to the computing device are not readily distinguishable from one another. For example, if a keyboard device A and keyboard device B are both attached to one computing device, and the user types on both keyboards simultaneously, the input from both keyboard devices will be routed to the same application that has registered for keyboard data. This causes the keystrokes of both keyboard devices to be intermingled on the user interface.

There are several approaches available in the industry today to support simultaneous access to Human Interface Device (HID) type devices. The following describes some approaches, and their limitations. The Apple™ HID Manager is the standard USB HID Application Programming Interface (API) on Mac™ OS X. It also includes Apple™ Desktop Bus (ADB) devices, like PowerBook™ keyboards and trackpads. The Linux™ Input Subsystem, represented by “input.h,” is a very clean and simple API that unifies a number of APIs: USB HID, PS/2, Wacom, serial mice, ADB, and more. It has become the standard method for handling input devices in the vast majority of GNU/Linux distributions. The Microsoft™ Windows™ Driver Development Kit (DDK) HID API is similar to the Apple™ HID Manager in that is a low-level API that closely follows USB HID.

### SUMMARY

Distinguishing the input among the various USB keyboard devices attached to one computer becomes a requirement when using devices that emulate keyboards. Such is the case with USB smartcard readers. Many USB smartcard readers today offer keyboard emulation models that allow smartcard data to be presented to the computer system as keystroke data. To avoid the keystroke data from the smartcard reader being indistinguishably intermingled with the keyboard data from an actual keyboard, embodiments described herein provide for distinguishing keystroke data among the several keyboard devices attached to, in communication with, or otherwise engaging the computing system, e.g., an MFP device.

Accordingly, embodiments pertain to systems and devices for, and methods of, enabling data input from multiple USB keyboard devices to be routed to multiple applications running on a computing device, e.g., a MFP device. Each connected USB keyboard device is associated with a separate thread that serves to monitor and manage the associated connected USB keyboard device. Threads are dynamically spawned when a keyboard device is attached, and threads are deleted when the device is detached. A keyboard manager thread embodiment performs the following functions: (a) manages multiple keyboard devices connected to the same machine; (b) provides a list of monitored keyboard devices available on the system; (c) processes and provides data for each keyboard device from the USB subsystem; (d) buffers data in memory pre-allocated for each device; (e) allows applications to register for events for each device; (f) sends events to registered applications; and (g) references a matching device criteria database to dynamically configure the particular devices that are to be monitored.

Exemplary embodiments include methods of accommodating a plurality of interface devices via a USB comprising: (a) receiving a set of interface device settings for an interface device, by a computing device comprising: (i) a processor and (ii) addressable memory comprising a set of device-matching criteria having one or more entries comprising interface device characteristics; (b) comparing, by the processor, the received set of interface device settings with one or more entries of the set of device-matching criteria database; and (c) if the received set of input device settings matches an entry of the set of device-matching criteria database, then spawning an interface device manager thread. If the received set of interface device settings matches an entry of the set of device-matching criteria database, then the method may include generating an input/output (“I/O”) device handle associated with the interface device. The spawning of the interface device manager thread is based on the generated I/O device handle. The interface device may be a keyboard device, and the computing device may be a multifunction peripheral device. The method may further include reading data from the interface device based on the generated I/O device handle.

A computing device embodiment may include; (a) a processor, and addressable memory comprising a set of device-matching criteria; where the processor is configured, e.g., by loading computer executable instructions, circuitry, or a combination of both, to: (i) compare a received set of interface device settings with one or more entries of the set of the device-matching criteria; and (ii) determine whether the received set of interface device settings matches an entry of the set of device-matching criteria, and, (iii) if a match is determined, then spawn an interface device manager thread. The processor may be further configured to generate an I/O device handle associated with the interface device if a match is determined. The processor may be further configured to spawn the interface device manager thread based on the generated I/O device handle. The interface device may be a keyboard device, e.g., a USB keyboard device, and the computing device may be a MFP device where the MFP device is configured to receive input from two or more USB keyboard devices. The processor may be further configured to read data from the interface device based on the generated I/O device handle.

### BRIEF DESCRIPTION OF THE DRAWINGS

Embodiments are illustrated by way of example and not limitation in the figures of the accompanying drawings, and in which:

FIG. 1 is a functional block diagram of an exemplary computing device;

FIG. 2 is a functional block diagram of a exemplary multifunction peripheral (MFP) device;

FIG. 3 is an exemplary sequence diagram depicting a sequence of events within the operation of a multiple keyboard device arrangement

FIG. 4A is an exemplary depiction of the keyboard functionality architecture for a single USB keyboard device connected to a computing device;

FIG. 4B is a functional block diagram depiction of the keyboard functionality architecture for multiple USB keyboard devices connected to a computing device;

FIG. 5 is a top-level logic flow diagram for exemplary criteria matching; and

FIG. 6 is a functional block diagram depiction of a multiple keyboard device manager interface.

### DETAILED DESCRIPTION

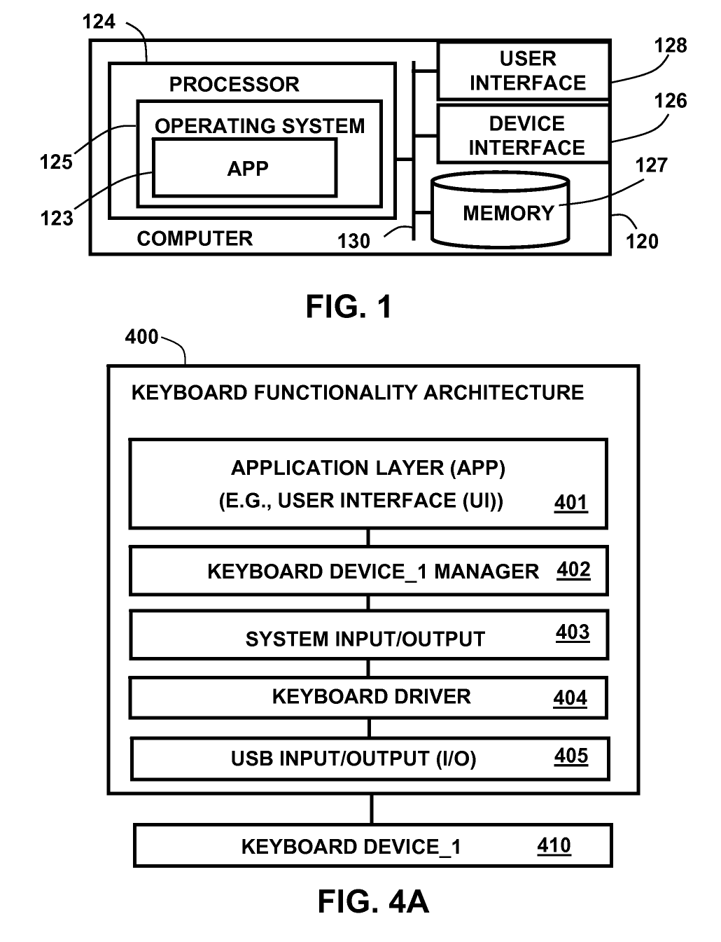

FIG. 1 depicts a computing device as an exemplary operating environment for multiple keyboard embodiments. The exemplary operating environment is shown as a computing device 120 comprising a processor 124, such as a central processing unit (CPU), addressable memory 127, an external device interface 126, e.g., a universal serial bus (USB) port and related processing, and an optional Ethernet port and related processing, and an optional user interface 128, e.g., an array of status lights and one or more toggle switches, and/or a display, and/or keyboard and/or pointer-mouse system and/or a touch screen. These elements may be in communication with one another via a data bus 130. Via an operating system 125 such as one supporting a web browser and applications, the processor 124 may be configured to execute steps of making reference to a Keyboard Matching Criteria Database and thread spawning 123 according to the exemplary embodiments described herein.

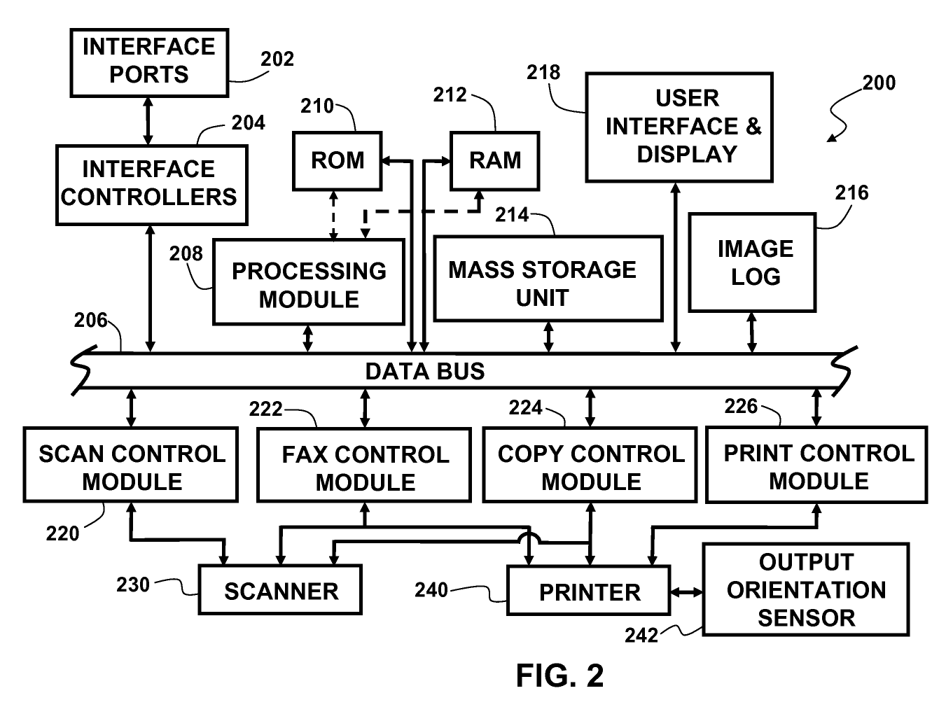

Another exemplary computing device is an exemplary MFP device illustrated in greater exemplary functional detail in FIG. 2. The MFP device may comprise various CPU, ROM, RAM, I/O devices, mass storage devices, and other hardware components necessary for proper functioning of the device. In addition to the hardware components required for proper functioning of the device, the MFP device provides USB connections for attaching USB-type devices to the MFP device. Interface ports 202 may be present to connect a printer cable, a USB device, a network link, or an external wireless module. The interface ports 202 may be serviced by one or more interface controllers 204 that function to direct communications and/or condition signals between the respective interface port 202 and one or more modules of the MFP device 200 which may be in common communication via a data bus 206. The MFP device 200 may include one or more processing modules 208, e.g., a processor executing instructions and/or computing circuitry, that may draw data from read-only memory (ROM) 210 and exchange data with random access memory (RAM) 212 and may store files having sizes greater than the RAM 212 capacity in one or more mass storage units 214. The MFP device 200 may maintain a log of its images 216 and have a user display and interface 218. The image log 216 may be a separate component or distributed, for example, with a portion executed via the processing module 208 that may access parameters, files, and/or indices that may be stored in ROM 210, RAM 212, a mass storage unit 214 or in combination thereof. The MFP device 200 may include as individual or separate modules a scan control module 220, a facsimile (FAX) control module 222, and a copy control module 224 where each module may service the scanner 230 to direct communications and/or conditions signals between the scanner 230 and one or more modules of the MFP device 200, for example, via the data bus 206. The MFP device 200 may include as individual or separate modules the FAX control module 222, the copy control module 224, and a print control module 226 where each module may service the printer 240 to direct communications and/or condition signals between the printer 240 and the one or more modules of the MFP device 200, for example, via the data bus 206. The exemplary MFP device 200 may store a calibration table in ROM 210, RAM 212, a mass storage unit 214 or in combination thereof and accordingly, the calibration table may be accessed by the print control module 226 and/or a processing module 208 and made available to devices external to the MFP device 200 via one or more interface ports 202, e.g., one or more keyboard devices connected via USB ports. The exemplary MFP device 200 may have notice, for example, due to a user input via the user interface 218, or sensed by an output orientation sensor 242 of the printer 240 and may be communicated via the print control module 226 to devices external to the MFP device 200 via one or more interface ports 202.

The computing device (FIG. 1) or MFP device (FIG. 2) may comprise one or more operating systems, such as vxWorks™ or Linux™. In addition to firmware for the proper function of the remote machine, the MFP device includes a USB stack to support USB-type device connections. The MFP device has one USB keyboard attached to one USB port on the MFP device, and a USB keyboard-emulated reader attached to another USB port on the MFP device. Both devices appear as a USB keyboard-class device to the operating system of the MFP device. Keystrokes from the actual USB keyboard device appear on the front panel UI interface, and keystrokes from the USB keyboard-emulated reader are routed to a login management component.

### Multi-Keyboard Overview and Multi-Keyboard Sequence

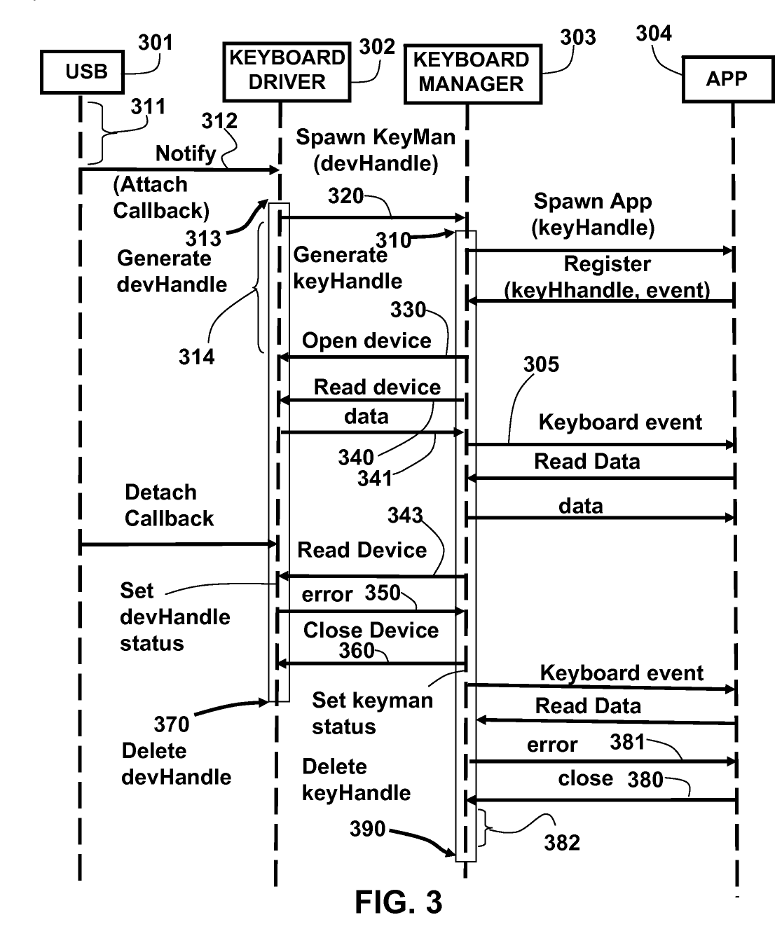

FIG. 3 is an exemplary sequence diagram depicting the sequence of events within the operation of a multiple keyboard device arrangement, e.g., the management of device handles and threads. Due to the nature of multi-threading, these sequences may not necessarily occur in the same sequence as shown in FIG. 3. Accordingly, FIG. 3 depicts elements of an exemplary system: a USB subsystem 301, a device driver such as keyboard driver 302, a device manager such as a keyboard manager 303, and an application 304 for a receiving device managed event data, such as keyboard event data 305. Within a multiple USB device embodiment such as the multi-keyboard embodiment of FIG. 3, the system executes some or all of the following steps: (a) detecting (311), by the USB subsystem 301, a USB device such as a keyboard device (not shown); (b) notifying (312) the one or more keyboard drivers 302, by the USB subsystem 301, of the detected attached keyboard device; (c) providing the keyboard drivers, by the USB subsystem, the device characteristics of the attached device; (d) generating (313), by the keyboard drivers (302), a device handle, e.g., “devHandle”; (e) comparing for a match (314), by the keyboard drivers, one or more characteristics of the USB device against the Device Matching Criteria; (f) if a match is found, then generating (310), by the keyboard drivers, a keyboard manager handle referencing keyboard device, e.g., “keyHandle”; (g) spawning (320), by the keyboard drivers, a keyboard manager thread referencing the new manager handle, e.g., “KeyMan(devHandle)”; (h) opening (330), by the keyboard manager 303, the device; (i) reading (340), by the keyboard manager, data (341) from the keyboard driver 302; (j) returning (350), by the keyboard drivers, an error at subsequent reads (343) when the device is detached; (k) detecting by the keyboard manager 303, one or more returned errors from the driver; (l) closing (360), by the keyboard manager, the device based on the detected one or more errors from the driver; (m) releasing, by the keyboard drivers 302, the I/O device handle (370), e.g., delete “devHandle”; (n) closing (380), by the application 304, the keyboard manager 303 based on detected one or more errors (381); (o) releasing (382), by the closed and exiting keyboard manager 303, memory; and (p) deleting (390), by the application 304, the keyboard manager thread, e.g., delete “keyHandle.”

### Keyboard Architecture

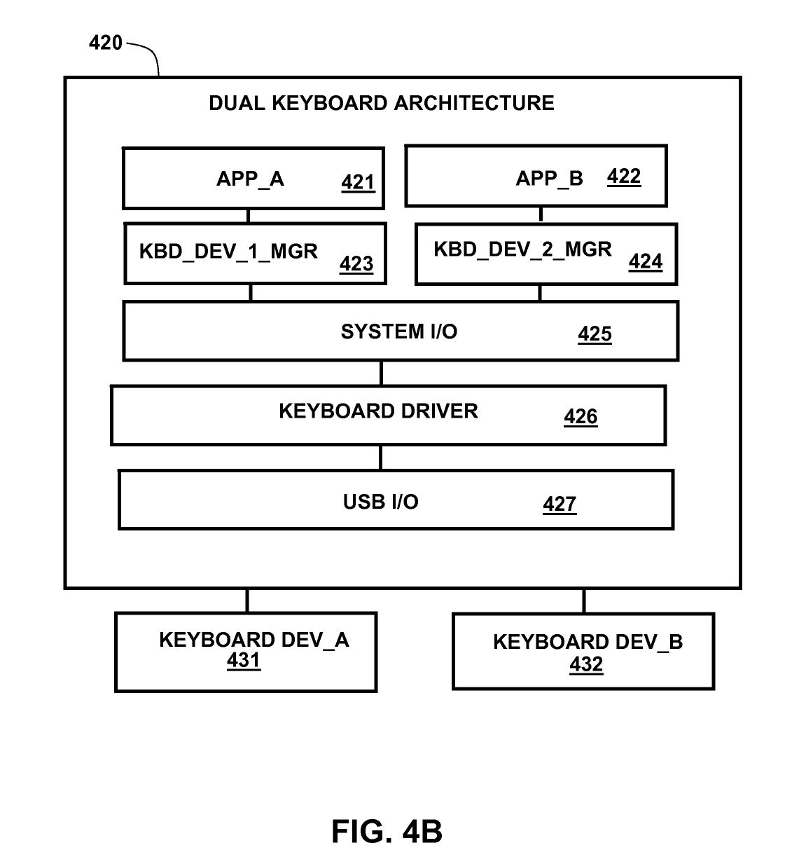

An exemplary structure for multiple keyboard attachment may be within a USB layered architecture. FIG. 4A depicts a keyboard functionality architecture 400 where, in this example, as single keyboard device (“keyboard device_1”) 410 is connected. Exemplary components of the structure are depicted in the functional block diagram of FIG. 4A as the keyboard (device_1) manager 402 and one or more keyboard drivers 404. Keystroke data originates from the lowest layer USB I/O component 405, and finishes at the upper layer i.e., the application layer 401, e.g., a user interface (UI) application. User input via a USB device moves from the USB input/output component 405 toward the uppermost layer in this example, i.e., the application layer that may be a user interface 401, by way of application program interfaces (APIs) and by way of the keyboard device manager layer 402, e.g., keyboard device_1 manager, and the applications interface to the keyboard manager, via a set of application program interfaces (APIs): the system I/O 403, and the keyboard driver 404. Applications may register for event notifications from the keyboard manager via the APIs, and applications may obtain keystroke data via the APIs. In particular, the keyboard manager may obtain keystroke data from the IO subsystem. The keyboard manager may provide to the I/O subsystem the keyboard device name from which data may be read, and provides the keystroke buffer to which data may be stored. After receiving keystroke data, the keyboard manager notifies registered applications of the data event. Each instance of the keyboard thread has its own memory, system resources, and variables, and each instance of the keyboard thread stores these variables within a handle. Accordingly, a new handle is created for each thread, and this handle is used by the application to access the specific keyboard device.

### Keyboard Manager

As an example of USB device management, the keyboard manager manages one keyboard device. A responsibility of the keyboard manager is to obtain data from the USB subsystem, and pass the data to the upper application layer. Multi-keyboard support employs dedicated keyboard manager threads where each thread is used to manage a particular connected USB keyboard device. Each thread may be dynamically spawned when a keyboard device is attached, and each thread may be deleted when the keyboard device is detached. Each thread uniquely identifies the device being managed and provides this information to applications interested in keystrokes from that device.

FIG. 4B depicts an exemplary multiple keyboard architecture 420. For example, Application_A 421 may receive keystrokes from device_A 431, and Application_B 422 may receive keystrokes from device_B 432 via USB I/O 427. Applications 421,422 interface to respective keyboard device managers 423, 424 through a set of application program interfaces (APIs).

### Keyboard Type

The keyboard type is an element to multi-keyboard support. A type “KEYBOARD” may be defined to identify keyboards, and a type “READER” may be defined to identify the reader. Each keyboard manager thread may uniquely identify the type of device it is managing, and each keyboard manager thread may provide this identity type information to the application, e.g., via the keyboard manager handle. The keyboard type is identified by the keyboard drivers 426 when the keyboard device is attached to the system 425. The keyboard driver provides this identifying information to the keyboard manager functions during the device attach callback step.

### Keyboard Matching Criteria

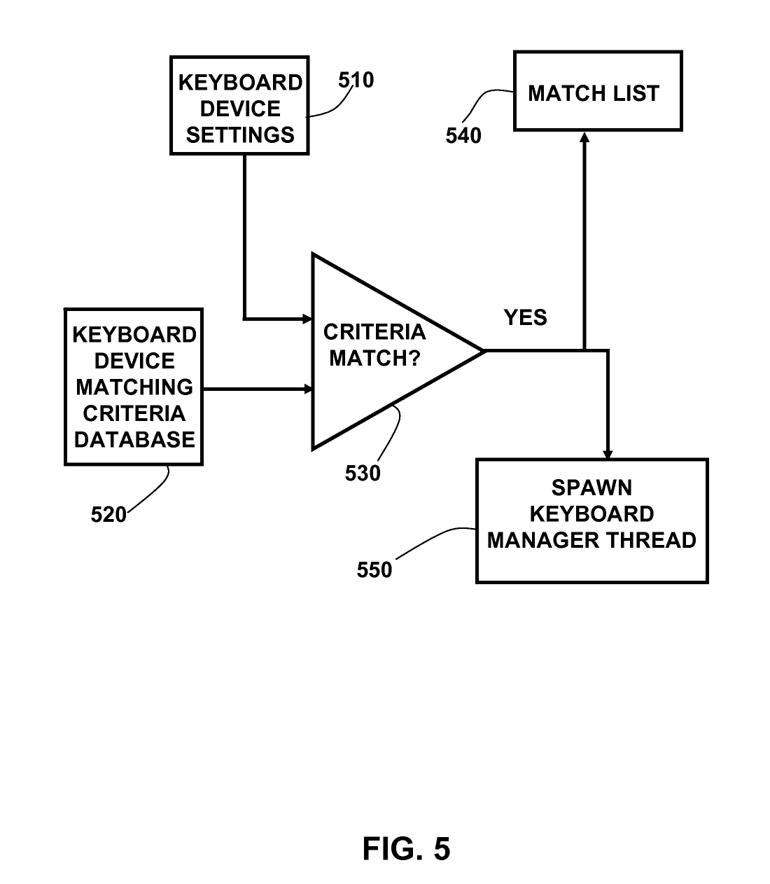

FIG. 5 illustrates in a top level logic flow chart the Keyboard Matching Criteria Database that may be used to identify the USB keyboards that may be monitored by the computing device, such as the MFP device. In exemplary embodiments, when devices are enumerated by the USB subsystem, the USB subsystem compares the settings 510 of the USB device, e.g., a keyboard device, against the keyboard matching criteria in the Keyboard Matching Criteria Database 520. If the keyboard device is found to be a match 530, then the keyboard device is added to an internal match list 540, and a keyboard manager thread is spawned 550 for the keyboard device.

The Keyboard Matching Criteria Database may be in the form of an XML file. Records may be added by modifying the XML file or added dynamically through system administration functionality. When the computing device, such as an MFP device, detects a newly attached keyboard device, the keyboard device information enumerated by the USB subsystem may be presented on the one or more administrative pages of the keyboard device, and the MFP device may allow the keyboard device to be added to the database automatically. Accordingly, differentiating keyboard devices allows the MFP device to route keystroke data appropriately via multiple managing threads in the system.

### Keyboard Manager Handle

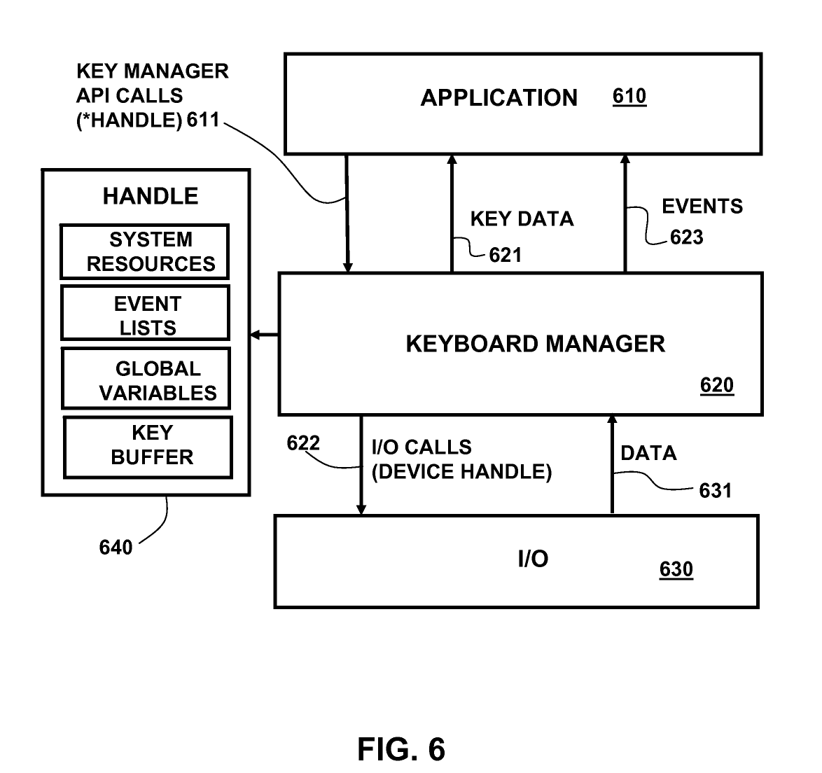

FIG. 6 depicts in a top-level block diagram the keyboard manager interface using thread-specific handles. Applications of the user interface 610 may register for event notifications from the keyboard manager 620 via the APIs 611, and allow for the applications 610 to obtain the keystroke data 621. The application provides to the keyboard manager 620 the keyboard handle 640 associated with the keyboard device from which data and events should be received. The keyboard manager 620 obtains keystroke data 631 from the I/O subsystem 630. The keyboard manager 620 provides to the I/O subsystem 630 the device handle 622 from which data that may be read, and the keyboard manager 620 provides the keystroke buffer to which data may be stored. After receiving keystroke data, the keyboard manager 620 may processes the data, and may notify registered applications 610 of the data event 623. Each instance of the keyboard thread makes use of its separately allocated memory, system resources, and variables, and these variables are stored within a handle. A new handle 640 is created for each keyboard manager thread, and this handle 640 is used by the application 610 to access the specific keyboard device.

The keyboard manager handle 640 enables the application of multiple keyboard manager threads. The handle may be created or generated when the USB subsystem detects a matching keyboard, and the handle is deleted when the application no longer requires services from this thread. The handle memory may be dynamically allocated prior to spawning the keyboard manager thread. The handle memory may be initialized to include the device name as well as other thread-specific information. This handle 640 may then be passed to the keyboard manager 620 at task entry, and may be made available to applications 610 that register for keystroke data. The information within the keyboard manager handle 640 may comprise: (a) a device name; (b) a device ID; (c) a device type; (d) a key buffer; and (e) system resources. The keyboard manager initializes the system resource encapsulated within the keyboard manager handle. An exemplary initialization includes allocating the memory buffers and generating semaphores specific to the attached device.

### Keyboard Drivers

The keyboard manager obtains data via keyboard drivers. The keyboard driver I/O functionality is internally mapped to the system I/O functions: read; write; open; close; and “ioctl,” i.e., I/O control. When a device is attached to the system, it is the keyboard driver that generates a new device handle for the attached device, and generates the I/O device name associated with the handle, e.g., “/usbKb/0.” The USB device, such as the keyboard device, may then be added to an internal device list maintained by the drivers. In addition to the management of the internal keyboard I/O device handle, the keyboard driver creates a keyboard manager handle associated with this device and stores a reference to the I/O device handle in the keyboard manager handle.

In addition to generating a handle, the handle is initialized, and the keyboard manager thread is spawned for managing that device. When a keyboard device is disconnected, the keyboard drivers release memory and remove the keyboard device from the internal device list maintained by the drivers.

### Application Interface

Applications receive keystrokes by registering with the keyboard manager. To do this, applications exercise the public APIs provided by the keyboard manager to provide a list of events that the application will service. The identification of a keyboard manager thread is based on the handle of the appropriate keyboard manager thread. To register for events, the application may provide the list of events to identify the keyboard manager thread with which to register. An exemplary process by which applications may obtain the keyboard manager handle is at the stage of task entry. That is, the keyboard manager thread itself may be used to spawn the application thread, and to provide its own handle at the application task entry. Another exemplary process by which applications may obtain the keyboard manager handle may be for the keyboard manager to maintain a list of all running threads, and provide this list through a public API.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention herein disclosed by way of examples and section headings, should not be limited by the particular language of the section headings and/or the disclosed embodiments described above.

What is claimed is:

1. A method of accommodating a plurality of interface devices via a Universal Serial Bus (USB) comprising:
receiving a set of interface device settings for an interface device, by a computing device comprising: (a) a processor and (b) addressable memory comprising a set of device-matching criteria having one or more entries comprising interface device characteristics;
comparing, by the processor, the received set of interface device settings with one or more entries of the set of device-matching criteria database; and
if the received set of input device settings matches an entry of the set of device-matching criteria database, then:
spawning an interface device manager thread.

2. The method of claim 1 wherein: if the received set of interface device settings matches an entry of the set of device-matching criteria database, then generating an input/output device handle associated with the interface device.

3. The method of claim 2 wherein the spawning of the interface device manager thread is based on the generated input/output device handle.

4. The method of claim 1 wherein the interface device is a keyboard device.

5. The method of claim 1 wherein the computing device is a multifunction peripheral device.

6. The method of claim 1 further comprising reading data from the interface device based on the generated input/output device handle.

7. A computing device comprising:
a processor, and addressable memory comprising a set of device-matching criteria;
the processor configured to:
compare a received set of interface device settings with one or more entries of the set of the device-matching criteria; and
determine whether the received set of interface device settings matches an entry of the set of device-matching criteria, and, if a match is determined, then:
spawn an interface device manager thread.

8. The computing device of claim 7 wherein the processor is further configured to generate an input/output device handle associated with the interface device if a match is determined.

9. The computing device of claim 8 wherein the processor is further configured to spawn the interface device manager thread based on the generated input/output device handle.

10. The computing device of claim 7 wherein the interface device is a keyboard device.

11. The computing device of claim 7 wherein the computing device is a multifunction peripheral device.

12. The computing device of claim 8 wherein the processor is further configured to read data from the interface device based on the generated input/output device handle.

13. The computing device of claim 7 wherein the interface device is a Universal Serial Bus (USB) keyboard device.

14. The computing device of claim 7 wherein the computing device is a multifunction peripheral device configured to receive input from two or more Universal Serial Bus (USB) keyboard devices.
